(19) United States
(12) Patent Application Publication
(10) Pub. No.: US 2002/0004771 A1
(43) Pub. Date: Jan. 10, 2002

(54) Employee deferred income system and method

(76) Inventor: Amos Eugene McCain, Miami, FL (US)

Correspondence Address: WILLIAM E. JOHNSON, JR., THE MATTHEWS FIRM, 1900 WEST LOOP SOUTH, STE. 1800, HOUSTON, TX, 77027, US

(21) Appl. No.: 09/865,410

(22) Filed: May 25, 2001

Related U.S. Application Data
(60) Provisional application No. 60/206,962, filed on May 25, 2000.

(51) Int. Cl. G06F 17/60

(52) U.S. Cl. 705/35

(57) ABSTRACT

The present invention provides a system and method for setting up an employee deferred income plan that may preferably be utilized for various purposes such as to delay taxation of the deferred amounts, to avoid inclusion of the deferred amounts in the income of the employer, to avoid the possibility that the employer's creditors can obtain the deferred amount, and to permit any percentage of the employees income to be deferred. The plan provides that a taxable employer has an agreement with a non-taxable entity regarding income due to the taxable employer from the non-taxable entity. Under the agreement, the non-taxable entity or an agent thereof will remit to an indemnification trust fund an amount equal to the employee's elected deferred amount in order to indemnify the taxable employer for the deferred amount which the taxable employer has promised to pay the employee upon the occurrence of a payable event. In a preferred embodiment, the entire balance of the undistributed corpus of the deferral account is subject to a risk of forfeiture for the entire payout period, as periodic payable events occur over time, thereby dissipating the account assets to zero.

### TECHNICAL FIELD

The present invention comprises a system and method for deferring employee income. Specifically, it relates to an improved system and method of allowing selected employees of taxable employers the opportunity to electively pretax defer any selected portion of their salary, without a concomitant increase in the taxable income to the employer, in those cases wherein the taxable employer receives at least a portion of its income from one or more non-taxable entities, so long as the aggregate employees' deferral amount is no greater than that portion of the employer's income derived from one or more non-taxable entities.

### BACKGROUND ART

The present invention is for a two-plan tandem system of non-qualified deferred compensation plans which operates to provide a unique method for administering pretax savings and investment vehicles for the benefit of employees of taxable employers.

The prior art includes U.S. Pat. No. 5,913,198, “System and method for designing and administering survivor benefit plans;” U.S. Pat. No. 5,911,135, “System for managing financial accounts by reallocating funds among accounts;” U.S. Pat. No. 5,884,285, “System for managing financial accounts by a priority allocation of funds among accounts;” and U.S. Pat. No. 5,878,405, “Pension planning and liquidity management system.” As opposed to the prior art, the method of the present invention falls into an area of the United States of America Internal Revenue Code which allows a highly compensated employee to benefit from pretax deferral of salary without the restrictions on deferral amounts or the timing of benefit distributions inherent in qualified retirement plans. One key is the non-taxable status of the payor entity, e.g., a governmental Medicaid funding agency or 501(c)(3) organization which operates as payor to the employer/payee, e.g., a taxable hospital or professional corporation or association.

The present invention's tax-sheltered savings and investment system and method is designed under a format called a “non-qualified deferred compensation plan,” with “plan” meaning the written form of agreement between the employer and employees concerning the deferrals. The term “non-qualified” means that such vehicles are not intended to meet all the limiting requirements of the United States Internal Revenue Code §§ 401(a) and 401(k) having to do with nondiscrimination as to eligibility, coverage, and contributions or benefits. Non-qualified plans can be designed to achieve all the desirable tax-sheltered benefits of “qualified” plans, without all the red tape, expense, and complications of qualified plans.

Under a non-qualified plan, the employer may discriminate in favor of key employees, and establish whatever benefit or contribution formula works to its best advantage in achieving the particular objectives of any individual situation.

Historically, these plans have most often been used in situations involving a taxable employer and key employees which the employer was interested in retaining on a continuing basis because of their value to the corporation. This form of plan is commonly referred to as a “Golden Handcuffs” plan, since it binds the key employees to the employer with the written promise to pay future benefits to them as a reward for their continuous faithful service. In recent times, this same form of plan has become very popular with non-taxable employers, with the benefits usually based entirely on deferral account accumulations which are the result of employee elective pretax deferrals.

Non-qualified plans ordinarily provide for the establishment of an individual account maintained for the benefit of each covered employee, with the publication of periodic account statements which are provided to them on a regular basis, as a means of continuing reinforcement to them that they are receiving a valuable benefit from the employer. These arrangements can provide for various combinations of employer contributions and employee pretax salary deferrals to their accounts. In fact, these plans can provide that any employer contributions made to deferral accounts are geared wholly or in part to employee elective deferrals.

Under a non-qualified deferred compensation plan, a taxable employer is allowed a tax deduction, but not until the benefits are paid out. This is in contrast to the current tax deduction which the employer is allowed to take under a qualified plan; but in the qualified plan, the employer is not allowed the privilege of discrimination. So, what we learn about this, is that there is a trade off which occurs: The trade off is that if a taxable employer wants the current deduction, he must not discriminate in the terms of the plan with respect to either eligibility for coverage, and benefits or contributions. If discrimination is desired, then the tax deduction must be deferred. As far as the participant is concerned, the taxability is pretty much the same between the two types of plans, when the employer is a taxable corporation. Internal Revenue Code Section 451 provides in general that the income tax is payable by the participant only when the plan benefit payments are actually received by, or otherwise made available to him.

Under these plans, the employer (taxable or non-taxable alike) will ordinarily select an insurance company product for the purpose of making plan investments. This method of investment selection achieves several employer objectives simultaneously, including account maintenance that is simple and inexpensive, and employee confidence that is maximized by having one or more well known respected outside financial institutions provide the services of both account administration and investment portfolio management.

The principal advantage of a non-qualified deferred compensation plan is that it allows the employer to discriminate in favor of the key employees, which is not possible under a qualified plan. In point of fact, in order to obtain an ERISA exemption for a non-governmental non-qualified plan, any such plan must be both unfunded and established primarily for the purpose of providing plan benefits to a select group of employees which consists of highly compensated or supervisory persons. As far as the employees are concerned, the principal difference is that the assets of the deferral account are held as assets of the employer, subject to the claims of the employer's general creditors, with the participants having equal status with other unsecured general creditors. However, this one disadvantage is offset by the many advantages obtained through the discriminatory features of the non-qualified form of plan. It is this trade off which makes non-qualified plans so attractive.

In the case of an employer which is not subject to tax, the same advantages are available to both employer and employees, except that Internal Revenue Code Section 457 applies to the plan, as follows:

1. Section 457(a) provides taxability of deferral amounts made under “eligible” plans (as defined in Sec. 457(b)) only as they are paid or otherwise made available; with such plans requiring deferral limitations, minimum benefit payout rapidity, and coordination of deferrals with 403(b) annuity and other plans; or

2. If the written language of the plan either intentionally or accidentally fails to meet all the requirements of Section 457(b), (c), and (d), then the plan is automatically a non-eligible plan, thereby activating the provisions of Sec. 457(f), which means that the deferrals will be included in a participant's gross taxable income in the first taxable year in which their rights to receive the deferred amounts are not subject to a substantial risk of forfeiture. The language of an eligible plan will always give participants non-forfeitable rights to receive benefits, but plan language which is unrelated to non-forfeitability could make the plan a non-eligible plan, even if only by accident. For this reason, it is important that an employer knows in advance that its plan is drafted in language which deals properly with 457(b) or 457(f), based on the intended result to be obtained by the plan.

The obvious principal disadvantage of a non-qualified plan is the exposure of account assets to employer creditor claims. We believe that the present invention deals effectively with this disadvantage, by removing the creditor claims issue, through the establishment of a “funded” trust, wherein the assets are held in trust by the Payor for the exclusive benefit of the Payee corporation, unlike a “Rabbi Trust,” which is an “unfunded” trust accessible to the creditors of the grantor corporation in the event of an insolvency or bankruptcy.

### QUESTION AND ANSWER INTRODUCTION TO 457

1. What is a deferred compensation plan?

Any arrangement under which the current receipt of compensation for services rendered is deferred until a future time, usually established so as to also defer current income taxability on the deferral amounts. These plans take many different forms, providing for either employer contributions or employee elective deferrals, or both. There are two main types of deferred compensation plans: “qualified,” and “non-qualified.” The tax treatment of these plans is determined by various sections of the Internal Revenue Code, depending on the type of employer, and/or the type of plan, and are ordinarily known by the number of the Code Section which principally applies to or defines them. Secs. 401(a), 401(k), 403(b), 405(a), and 408(a) and (b) define the various qualified plans, while Sees. 451, 457, and 83 determine taxability of non-qualified plans. All qualified plans are required to be both written and funded, while non-qualified plans are not. However, for purposes of establishing clarity of intent, nearly all non-qualified plans are written plans.

2. What is a 457 Deferred Compensation Plan?

Any non-qualified differed compensation plan sponsored by an “eligible employer,” as defined in Internal Revenue Code Section 457(e)(1)(A) or (B). In general, any non-taxable employer's plan.

3. Are there different kinds of 457 Plans?

There are three types: “eligible,” “non-eligible,” and “excepted.” Eligible plans are called “457(b)” Plans because they conform to the requirement of Code Sec. 457(b). Tax treatment of deferrals made under eligible plans is determined by Sec. 457(a). Deferrals made under non-eligible plans are taxed in accordance with the provisions of Sec. 457(f), and thus are called “457(f)” Plans. Excepted Plans are simply not covered by any of the provisions of Sec. 457, but they must initially attain, and thereafter continue to maintain conformity with the applicable exception requirements, to avoid being treated as 457(f) plans. The IRS likes to call 457(f) Plans “ineligible plans,” but there is no statutory authority for the use of that term.

4. What is the difference in tax treatment between 457(a) and 457(f)?

Sec. 457(a) provides that under an eligible plan, any amount of compensation deferred under the plan, and any income attributable to amounts so deferred, shall be includible in gross income only for the taxable year in which such compensation or other income is paid or otherwise made available to a participant or other beneficiary. On the other hand, Sec. 457(f)(1)(A) provides that if an eligible employer's plan is not an eligible plan, then the deferred compensation shall be included in the gross income of the participant or beneficiary for the 1^{st} taxable year in which there is no substantial risk of forfeiture of the rights to such compensation. Sec. 457(f)(3)(B) follows up, by defining that a risk of forfeiture exists when the rights of a person to compensation are subject to a substantial risk of forfeiture if such person's rights to such compensation are conditioned upon the future performance of substantial services by any individual. Thus, an eligible employer's non-eligible plan can provide pretax deferrals only so long as a risk of forfeiture exists.

5. What kinds of plans are “excepted plans?”

Sec. 457(e)(11) excludes bona fide vacation leave, sick leave, c severance pay, disability pay, or death benefit plans. However, the exclusion does not apply to so-called 457 deferred comp/severance pay plans which provide for elective deferrals. These plans are covered by 457(f).

Sec. 457(e)(12) excepts plans which provide only for the non-elective deferral of compensation earned by non-employees.

Sec. 457(e)(13) excepts churches from the definition of eligible employer, thereby removing church plans from coverage by Sec. 457.

In general, if a plan is an excepted plan, Code Sec. 451(a) applies in determining the taxability of benefits to participants, subject to any other exceptions or exclusions which may apply.

6. Are there similarities between 451(a) and 457(a)?

They are very similar, in that the deferral amounts are includible in gross income only for the taxable year when paid or otherwise made available, regardless of whether a risk of forfeiture exists under the arrangement.

7. What are the differences between 451(a) and 457(a)?

Post-separation benefit elections under 457(b) plans are explicitly sanctioned by 457(a) and the underlying tax regulations, but under current IRS interpretation, 451(a) permits no such deferred elections. This is because 451(a) does not deal with any particular kind of deferred compensation plan, as 457(a) does. Instead, 451(a) applies a broad brush to the timing of the year of inclusion in gross income of all gains, profits, and income. Thus, 451(a) provides no deferral limits, coordination rules, nor rapidity of payouts; instead, it is only determines the year of inclusion in gross income of amounts deferred, unless the plan or arrangement is covered by another Code Section, such as any of those previously mentioned.

8. Does Sec. 457 treat all contributions and deferrals alike?

Yes, elective and non-elective deferrals are considered together, unless the plan is an excepted plan, in which case no part of 457 applies to the plan.

9. Can a 457(b) Plan become treated as a 457(f) Plan through no employer intent? If so, how?

An eligible plan can lose its status by improper administration of any of its 457(b) requirements, whether through sloppiness, or by design. So long as a plan's language meets these requirements, a governmental employer has a grace period to clean up any non-qualifying problems of a purely administrative nature. The grace period allows a governmental employer to correct any inconsistencies prior to the beginning of the 1^{st} taxable year which begins more than 180 days following notice to the employer from the Treasury Secretary that the plan is being administered in an inconsistent manner. However, this grace period does not apply to non-governmental plans.

10. Are there other differences between governmental and other plans?

Yes. Non-qualified plans sponsored by non-governmental eligible employers are subject to ERISA, unless such plans are unfunded, and established primarily for the purpose of providing benefits to a select group which consists of supervisory or highly compensated employees.

11. What are the requirements imposed on eligible plans by 457(b)?

Only individuals (natural persons) may be participants.

Annual deferral limit is 33⅓% of the participant's includible compensation (25% of gross compensation), up to $7,500, exclusive of any catch-up deferrals, as modified by the 457(c) coordination rules, which produce severe limitations on deferrals when a participant also participates in another plan or plans, such as 401(k), 403(b) annuities, SEP's, and trusts maintained under Sec. 501(c)(18). “Catch-up” deferrals may be made with respect to prior years in which maximum permitted deferrals (taking 457(c) into account) were not made. Eligible plans must specify that catch-up deferrals up to $15,000 can only be made in one or more of the last three years, ending prior to a participant attaining normal retirement age, and that such deferral amounts take into account only underutilized deferrals under an existing eligible plan.

Deferrals can commence only with respect to a pay period which begins no earlier than the first day of the month following the execution of a deferral agreement.

The plan must be unfunded (see note following question 15 below).

Distributions may not commence to a participant or beneficiary earlier than the participant's separation from service for any reason, or in the event of an “unforeseeable emergency.”

Distributions may not commence later than 60 days following the end of the plan year in which the participant attains, or would have attained age 70½, whether actually retired or not.

Distributions, when made, must be paid out over a period no longer than as prescribed in Code Secs. 401(a)(9) or 457(d)(2)(B)(i). Basically, these requirements provide for rapidity of payout over a period of time not longer than the lifetime of the participant, or the joint lives of the participant and spousal beneficiary. In addition, non-spousal death benefits must commence within 60 days following death, and must be paid out over 15 years, or the beneficiary's life expectancy, if less.

A plan must provide for irrevocable benefit commencement date and payout mode elections, which must be made:

a) For commencement date: within 30 days following separation from service.

b) For payout mode: no later than 30 days before the benefit commencement date.

A plan must specify both a standard benefit commencement date and payout mode, in the event a participant has not made a timely election for these events.

12. What is the difference between “funded” and “unfunded” plans?

The assets generated by the existence of a funded plan are held for the exclusive benefit of participants and their beneficiaries, while the assets generated by an unfunded plan are held as assets of the employer, subject to the claims of the employer's general creditors, with the participants'status being that of general creditors, without protection or preference.

13. Does Sec. 457(f) require non-eligible plans to be unfunded plans?

No. It is important to understand that 457(f) has no “requirements.” However, as previously noted, 457(f) makes it impossible for an eligible employer to establish and maintain a non-eligible pretax deferred compensation plan unless the plan provides that participants' rights to receive benefits under the plan are conditioned upon a requirement of the future performance of substantial services. If a non-governmental 457(f) Plan is funded, then it becomes subject to ERISA's funding standards and reporting requirements, but the creditor shield and the tax shelter remain intact.

14. What about transfers and/or rollovers involving 457 Plan assets?

Non-taxable rollovers and transfers are not permitted between qualified and non-qualified plans, nor between eligible and non-eligible 457 plans. However, plan-to-plan transfers may be made from one eligible 457 Plan to another eligible plan, provided both plans permit such transfers, as provided by 457(e)(10). In the case of transfers between 457(f) Plans, the facts and circumstances of any particular case would apply in determining tax consequences.

15. Why is “substantial risk of forfeiture” an important concept?

All taxable employers and non-governmental non-taxable employers have very obvious non-tax business reasons for having substantial risk of forfeiture provisions in their plans with respect to non-elective contributions. In these situations, such provisions operate to create “golden handcuffs.” The situation is different, however, with purely elective deferrals. Since there are only non-business tax reasons for risk of forfeiture provisions in elective-only deferral arrangements, these kinds of plans will not pass the scrutiny of an IRS audit, because of the Robinson v. Commissioner federal court case in 1986, in which the court ruled that a plan established for no reason other than tax avoidance is not entitled to the tax avoidance. However, plans involving non-elective deferrals are presumed to have been established with valid business reasons, so that in the following two situations, employees are able to enjoy tax advantages because of the non-tax, business reasons also present:

1. The employer wants the plan to be funded, thereby shielding the participants from the claims of employer creditors; and or

2. The employer is an eligible employer under Sec. 457, and wants a plan without one or more of 457(b)'s limiting requirements, and is willing to make a contribution to the Plan.

In either of these situations, the deferral amounts will not be includible in gross income of a participant until the year or years in which the risk of forfeiture lapses.

IMPORTANT NOTE: P.L. 104-188 (Also known as the Small Business Job Protection Act) made several changes in Code Section 457, the most important of which are: 1) Governmental plans must be funded plans; 2) The $7,500 deferral limit is tied to the COLA set by the Secretary of the Treasury; 3) Plans can now provide for in-service distributions in situations where an account of $3,500 or less has lain dormant for at least two years; 4) An elimination of the adverse effect of Code section 415 on eligible plans; and 5) Plans may give participants the one-time only right to elect a deferral of a benefit commencement date at any time before such date. The effective date for these changes is Aug. 20, 1996, except that governmental plans in existence prior to that date are not subject to the funding requirement until Jan. 1, 1999.

### A HISTORICAL REVIEW OF THE PHRASE “SUBSTANTIAL RISK OF FORFEITURE” WITHIN THE CONTEXT OF ITS IMPACT ON 457(f) AND FUNDED 451(a) DEFERRED COMPENSATION PLANS

“Deferred Compensation Plan” means any form of arrangement which provides for the deferral of the receipt of income earned today until some future time. These arrangements have historically taken many different forms, usually aimed at providing some form of tax shelter to both employer and participants in the process. This began with the Federal Income Tax Code of 1921, which followed the ratification of the 16^{th} Amendment to the Constitution (the income tax enabling amendment) by some eight years. The Code of 1921 provided that an employer could take a current tax deduction for a contribution made to a “qualified” profit sharing plan, even though taxability to the participants would not occur until they received retirement benefits.

Simply put, the term “qualified,” as it applies to retirement plans, means that if a plan of deferred compensation meets the requirements of the Code, then it “qualifies” the employer, the participants, and the funding device for favorable tax treatment. For example, if a plan meets the requirements of Code Section 401(a) as a pension or profit sharing plan, that plan is then “qualified” to receive the favorable tax treatment afforded by Sections 404(a), 402(a), and 501(a) of the Code. This means that employer tax-deductibility, non-taxability to the employees, and tax free income status of the funding device are all allowed to exist simultaneously.

As the years passed following the Code of 1921, the qualification rules were expanded to include pension plans (1938); thrift and stock bonus plans (1954); annuity plans for employees of certain tax-exempt organizations and public schools (1954 and 1961 respectively); and plans including self-employed individuals (1962). Then in the 1970's, Code Sections 408(IRA Plans) and 401(k) were added. Meanwhile, in addition to the liberal expansion of the types of plans which could be qualified, the 1954 Code introduced some restrictive complications, by imposing for the first time, nondiscriminatory coverage requirements.

Prior to 1954, an employer could establish a plan of funded deferred compensation for “some or all of its employees,” and the plan would be treated as a qualified plan. “Some or all” had become “a representative cross-section.” During the years following the 1954 Code, the rules concerning eligibility, coverage benefits or contributions, and vesting provisions have been tightened, until it has now become almost impossible for an employer to achieve any particular business purpose with a plan of qualified deferred compensation. This tightening of the rules took a quantum leap when congress enacted the Employees Retirement Income Security Act of 1974 (ERISA). More recent legislation, such as the Code of 1986, has operated to place employers in a figurative strait-jacket in establishing plans of qualified deferred compensation.

Because of the socialization of the rules applicable to qualified deferred compensation plans, employers have turned to various forms of “non-qualified” arrangements, in order to attract and retain key employees, which requires a discriminatory approach. In the early years of the development of such plans, it was believed by most plan designers that a non-qualified plan could be funded, thereby achieving the same insular effect from creditors as with a qualified plan. Therefore, it was reasoned, these discriminatory plans could operate very much like qualified plans, with only a couple of exceptions: 1) The employer deduction could only be taken when benefits were paid, and 2) The earnings of the funding device would be subject to taxability, except in the case of an insurance company product.

However, the Internal Revenue Service disagreed, and won in court, in a landmark case involving a Connecticut foundry. The court held that under a funded non-qualified plan, the employer would never be entitled to take a deduction for contributions, unless participants' rights to receive benefits were subject to a substantial risk of forfeiture, by such rights being conditioned on a requirement of their future performance of substantial services. This decision led to the post-retirement “consulting agreement” approach as a means of producing a “substantial risk of forfeiture,” thus allowing the employer a deduction when benefits are paid under a non-qualified funded deferred compensation plan. The IRS never liked these types of arrangements, since they were only a thinly disguised subterfuge. But the financial services industry had succeeded in making an end run on the IRS; which turned out to be a fleeting victory, as Congress then responded with the passage of Code Section 83, which provides a severe tightening of the definition of substantial risk of forfeiture.

With the passage of ERISA in 1974, more misery was piled on, by subjecting all funded deferred compensation plans to ERISA's filing requirements and funding standards. More recently, the First Circuit Court ruled in Robinson v. Commissioner, (1^{st} Cir. 1986), that such plans must have a non-tax business purpose. This ruled out funded elective-only deferral plans which also must contain substantial risk of forfeiture provisions for purely tax purposes.

Shortly prior to ERISA, there was a new development which was beginning to get the attention of the Treasury Tax Policy Division. It was unfunded non-qualified deferred compensation plans for non-taxable employers, primarily state and local governments. The rising popularity of these plans was causing a significant amount of revenue loss to the Treasury, primarily because there were no limits on the amounts deferred under such plans. Moreover, there were no rules concerning coordination with other plans or rapidity of payouts.

In 1977, the Treasury Department proposed Federal Income Tax Regulations which would tax deferrals when made under such plans. This caused a firestorm of intense lobbying by public employers and the financial services industry, which in turn, resulted in the enactment of the legislation which became codified as Internal Revenue Code Section 457, which singled out nontaxable employers as “eligible employers,” for purposes of establishing tax rules applicable to participants under plans established by such employers. Section 457(a) provides for taxability of benefits under “eligible plans” only as paid or otherwise made available to participants; however, 457(b), (c), and (d) provide that eligible plans must contain limits on deferral amounts, coordination rules, and rapidity of payout rules which are much more restrictive than those applicable to qualified plans.

In the language of this new legislation, 457(f) provided that if an eligible employer maintains a plan which is not an eligible plan, then the deferrals will be subject to inclusion in gross income for the payee in the first taxable year in which the payee's right to receive the deferred compensation is not subject to a substantial risk of forfeiture. This language was no doubt borrowed from Section 83, which had its roots in the old Connecticut decision. In this manner, the Congress intended to produce practical limitations on amounts which could be tax-sheltered under all forms of deferred compensation plans maintained by non-taxable employers.

Accordingly, an improved employee deferred income system and method is described.

### SUMMARY OF THE INVENTION

An objective of the present invention is to provide an improved deferred income plan for a taxable employer and the employees thereof.

A feature of one embodiment of the present invention is a trust fund that may be administered by a non-taxable entity or an agent of the non-taxable entity.

An advantage of a preferred embodiment of the present invention is delayed taxation of the employee for the deferred amounts.

Another advantage of a preferred embodiment of the present invention is the avoidance of the need for inclusion of the deferred amounts in the income of the employer.

Yet another advantage of a preferred embodiment of the present invention is avoidance of the possibility that the employer's creditors can obtain the deferred amount.

Yet another advantage of a preferred embodiment of the present invention is the possibility of deferring any percentage of the employee's income.

These and other objects, features, and advantages of the present invention will become apparent from the drawings, the descriptions given herein, and the appended claims. It will be understood that the described objects, features, and advantages listed herein are provided only for explaining the invention to those skilled in the art and that therefore the invention is not intended to be limited by any listed objectives, features, and advantages.

In one preferred embodiment, the present invention comprises a method for a deferred income plan for one or more employees of a taxable employer. The taxable employer is a payee of a non-taxable entity. The method comprises one or more steps such as, for instance providing that an employee of the taxable employer elects to defer at least some portion of the employee's salary from the taxable employer, providing that the taxable employer has an obligation to pay the employee the deferred portion at a future time, providing that the taxable employer elects to defer a deferred amount equal to the deferred portion of the employee's salary from income payable to the taxable employer from the non-taxable entity, providing that the non-taxable entity establishes a trust account to indemnify the taxable employer against the obligation to pay the employee the deferred portion such that the deferred amount is deposited into the trust account, and providing that a first payable event triggers a payment of at least a portion of the deferred amount from the indemnification trust account.

The method may also comprise steps such as providing that the non-taxable entity administers the trust account and/or that an agent of the non-taxable entity administers the trust account and/or providing that the taxable employer acts as the agent of the non-taxable entity to administer the trust account. In one embodiment, the taxable employer preferably remits the deferred amount into the trust account and the non-taxable entity reimburses the taxable employer for the deferred amount. The method may comprise providing that the trust account is for the benefit of the taxable employer and/or provide that the payment is made to the taxable employer who then forwards an amount equal to the payment to the employee and/or provide that the payment is made directly to the employee. In one embodiment, the trust account is set up in the name of the employee and/or benefits the employer. Preferably at least a portion of the deferred amount in the trust fund is subject to a risk of forfeiture until an occurrence of the first payable event. The risk of forfeiture may preferably continue throughout an accumulation period and a payout period.

The first payable event may be defined in an agreement between the taxable employer and the employee. In one embodiment, the method may comprise providing that the employee can elect any portion of the employee's salary.

Thus, a deferred income system for use in paying deferred income to one or more employees of a taxable employer is provided wherein a non-taxable entity has a first obligation to the taxable employer. The system may comprise elements, such as for instance, a second obligation by the taxable employer for payment of future benefits to the one or more employees corresponding to the deferred income. The system may comprise an agreement between the taxable employer and the non-taxable entity for payment of a portion of the first obligation such that a deferred amount equal to the deferred income will be utilized to fund one or more trust accounts for payment of the future benefits. As well, an agreement may preferably be provided between the taxable employer and the one or more employees with a provision for a payable event related to each of the one or more employees respectively which triggers a payment from a respective of the one or more trust accounts. The system may further comprise elements such as an election by each of the one or more employees for deferring the deferred income from a respective salary of each of the one or more employees and/or wherein the election may be for any amount up to an amount equal to the respective salary of a respective of the one or more employees.

In accord with the invention, a method is provided for setting up a deferred compensation plan. The method may comprise one or more steps such as, for instance, providing that as between a taxable employer and an employee of the taxable employer that the employee may elect to defer a deferred amount of income from the taxable employer to the employee, providing that as between the taxable employer and a non-taxable entity that the non-taxable entity will defer an amount from income to the taxable employer from the non-taxable entity equal to the deferred amount, providing for a trust account to be funded by an amount equal to the deferred amount, and providing for a payable event which triggers a payment from the trust account related to the deferred amount. Other steps may include providing that the deferred amount is subject to a risk of forfeiture until the payable event and/or providing that the taxable employer acts an agent of the non-taxable entity for administering the trust account.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a diagrammatic representation of the present invention.

### GENERAL DESCRIPTION AND PREFERRED MODE FOR CARRYING OUT THE INVENTION

The present invention, an improved employee deferred income system and method hereinafter referred to as the “Plan,” provides the Payor-a non-taxable entity, Payee, and the Payee's Employee/Participants with advantages they could not otherwise enjoy, through the use of several mechanical devices which are used in the two-plan tandem to create both a tax shelter and a creditor shield.

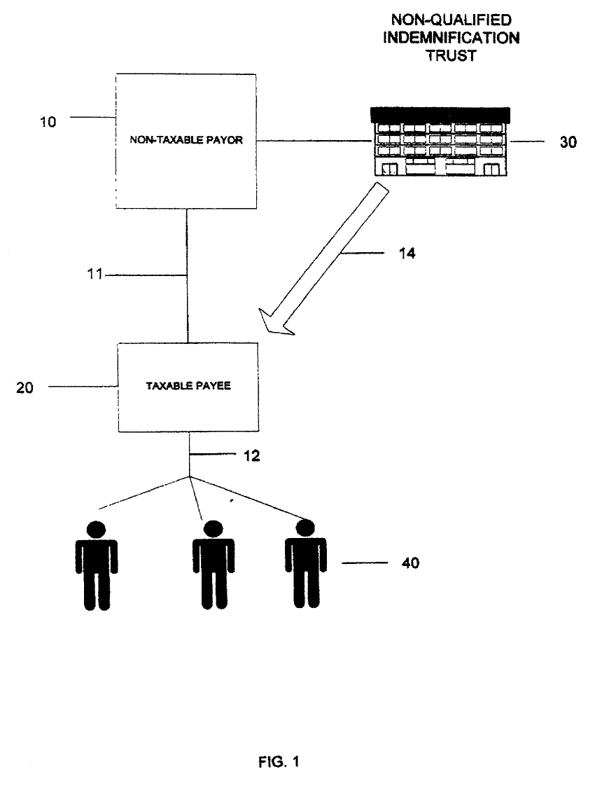

Referring now to FIG. 1, non-taxable entity 10 contracts or is obligated to pay employer/payee 20. One or more of employer's 20 employees 40 elect to defer at least some portion of their salary due them from employer 20, creating an unsecured promise by the employer 20 to pay future benefit amounts to the employees 40. In turn, the employer 20 agrees to defer an amount from its stream of income which flows from non-taxable entity 10 which is equal to the aggregate employee 40 deferrals, with such amounts being used by non-taxable entity 10 to establish non-qualified creditor-proof indemnification trust accounts 30 for the benefit of employer 20, the purpose of which is to indemnify employer 20 against the obligations created by the unsecured promise to pay future benefits to employees 40. The trust accounts are administered by non-taxable entity 10 or an agent of non-taxable entity 10. The amount of benefits to employees 40 is based on the investment results obtained by indemnification trust fund accounts 30. The timing of the benefit payments is determined by irrevocable elections made by employees 40 no later than the taxable year prior to the occurrence of a payable event which triggers the payments from the indemnification trust account to employer 20 who in turn forwards, or causes to be forwarded, the benefit payments to employees 40 as they are received. The net result of these transactions is that taxable income is received by the employer 20 with an equal and offsetting deduction for the payment to employees 40, and while the employees' 40 receive income which is taxable as it is received, reinvested income in the indemnification trust accounts is non-taxable, both during the employees' 40 working and retirement years, which creates the effect of a “tax-free money pump” within a plan that has nearly all of the beneficial characteristics of a conventional qualified retirement plan with none of the limitations, restrictions and maintenance costs associated with such plans. As opposed to prior art, the existence of the non-taxable entity, e.g., a governmental Medicaid funding agency or 501(c)(3) organization in this system's schematic achieves the following: 1) No increase in taxable income to the employer 20 as a result of employee 40 salary deferrals, 2) Elimination of the creditor claims issue normally associated with non-qualified retirement plans, and 3) A transfer of the onerous risk of forfeiture provisions inherent in funded non-qualified plans from the natural person employee 40 to the employer/payee 20, which as a corporation, unlike a natural person employee, has the ability to freely substitute people in the fulfillment of its obligations related to the future performance of substantial services by any individual.

The differences between a qualified and non-qualified plan are illustrated in Table 1.

TABLE 1

| Plan Type | QUALIFIED* | NON-QUALIFIED |
|---|---|---|
| Employer Type | Taxable Non-taxable, | Taxable, Non-taxable |
| | Ind. Tribe, | Ind. Tribe, other than |
| | or Churchˆ | or Churchˆ Churchesˆ |
| Asset Status | ALWAYS FUNDED+ | ALMOST ALWAYS |
| | | UNFUNDED+ |
| Code Sections | 401(a), (d), (k), 403(b), 405 | 451 457(b), |
| | & 408 | 457(e)(12), 83 or |
| | | 457(f) |
| Timing of | When contrib. N/A | When N/A |
| Employer | are made | Benefits are |
| Deduction | Sec. 404 | paid Sec. 404 |
| Timing of | When N/A | As Benefits 457(a): As |
| Employee | Contrib. | are paid # Benefits are |
| Taxability | are made | Sec, 451 Paid # |
| | Sec. 404 | 83 & 457(f) |
| | | When right to |
| | | receive |
| | | benefits is not |
| | | subject to |
| | | substantial risk of |
| | | forfeiture |
| Deferral Limits, | Yes Yes | No 457(b): Yes |
| Coordination | | 457(e)(12): No |
| Requirements & | | 457(f): No |
| Payout Rules | | 83: No |
| *Except for governmental plans, a qualified plan cannot discriminate against lower paid employees, or employer contributions will be taxable to participants when made. | | |
| + Funded plan assets are held exclusively for participants and their beneficiaries, unfunded plan assets are subject to employer creditor claims. Qualified plans must be funded, and except for governmental plans, are covered by ERISA; non-governmental plans must be unfunded “top-hat” plans to qualify for ERISA exemption. Governmental 457(b) plans in place on August 20, 1996 must be funded by January 1, 1999. New governmental 457(b) plans must be funded upon adoption. | | |
| #Employer contributions under other funded non-qualified plans are taxable to participants when their right to receive benefits is non-forfeitable. | | |

ˆ Churches are excepted from the definition of eligible employer by Sec. 457(e)(13); thus, Church plans are not subject to any Sec. 457 limitations. Church plans are also exempt by Sec. 4021(b)(3) from ERISA. Indian Tribes are covered by ERISA, but not by IRC Sec. 457.
# Or otherwise made available, such as merely giving a participant or beneficiary an option to accept or decline a benefit payment.

The system and method of the current invention is actually two plans in one, under which Part A is a 457(f) deferred compensation plan between an eligible employer and its corporate taxable independent contractors, and Part B is a 451(a) Plan between the independent contractor and its key common-law employees. For example, the Payor may be a non-taxable hospital (governmental or 501(c)(3)), and the Payee may be a medical professional association or corporation.

Benefit payments to the Payee under the Payor's Plan (Part A) are triggered by the Payee's periodic obligations to pay benefits to participants under the Payee's Plan (Part B). Part B provides for the deferral of income by key employees of a taxable employer, which means that Code Section 451(a) applies to the taxability of their benefits. Since Part A involves an “eligible employer” as Payor, and a corporate Payee, this plan is covered by 457(f). The deferral accounts are established under Part A as indemnification against obligations created under Part B. This combination results in zero net current tax liability to the taxable employer with respect to the deferrals made by the employees of the taxable employer.

### FEATURES

Benefits from the method of the present invention include the following illustrative but not limiting features:

1. Deferrals are untaxed to both the Taxable Employer and the Participants, just as under a qualified retirement plan.

2. The Deferral Accounts are held in trust by the Non-Taxable entity, and therefore accumulate Tax-Free, just as under a qualified plan.

3. Benefits are taxable to the Taxable Employer when paid, but they are simultaneously deductible as business because they flow directly when received to the individuals designated by the taxable employer to receive such benefits.

4. During the benefit payout period, the Deferral Account remains in place as a Tax-Free Money Pump.

5. There is NO LIMIT on amounts which may be deferred, and NONE of the limitations and other restrictive provisions of either the Internal Revenue Code or ERISA is applicable.

Table 2 illustrates the differences between the present invention and an exemplary prior art plan.

TABLE 2
PLAN COMPARISON TO AN EXEMPLARY PRIOR ART PLAN

| | EXEMPLARY | |
|---|---|---|
| | PRIOR | |
| | ART PLAN | PLAN |
| Provision for participant | No | Yes |
| elective deferrals | | |
| Undistributed Deferral A/C | No | No |
| Assets subject to Payor, | | |
| Payee, or Participant | | |
| Creditor Claims | | |
| Vested Deferral A/C Assets | Yes | Yesˆ |
| Subject to Payee Creditor | | |
| Claims* | | |
| Risk of Forfeiture to | Yes | Yes |
| Payee# | | |
| Risk of Forfeiture to | Yes | No |
| Participant + | | |
| Year of Taxability of | Entire Account at | Each Year, as Benefits |
| Benefits to Participant | Retirement | are Paidˆ |
| Plan Benefits Formulation | Defined Benefit | Money Purchase |
| *Benefit payments under either Plan could be subject to attachment as they pass through the Payee. | | |
| # Under both Secs. 83 and 457(f), the only way to avoid current tax liability is by conditioning the Payee's right to receive benefits on a requirement of the future performance of substantial services. | | |
| + The Exemplary Prior Art Plan has a risk of forfeiture provision applicable to Participants. Plan B of the Plan does not. | | |
| ˆ Under either Plan, benefit amounts payable from the Payor to the Payee are includible in Payee's gross income for the 1^{st} taxable year in which there is no substantial risk of forfeiture of the Payee's right to receive. Under the Exemplary Prior Art Plan, this right occurs when any given Participant's risk of forfeiture lapses under the Exemplary Prior | | |
| #Art Plan (when the service and age requirements are met). Under the Plan, all undistributed deferral account assets are continuously subject to this risk, during both the accumulation and payout periods. The lapse of forfeiture risk to the Payee occurs under the Plan only with respect to benefit payment obligations to Participants which are triggered as a result of the occurrence of a payable event under the provisions of Plan B, thereby activating the indemnification provisions of Plan A. | | |

It is this incrementally periodic lapsing of the risk of forfeiture under Plan A that gives the Plan the edge in any comparison to other such arrangements.

In the operation of the preferred embodiment, Payor, a non-taxable entity, sets up a trust account maintained by Payor for the benefit of Payee as an instrument of indemnification against obligations created by the non-qualified deferred compensation plan maintained by Payee for certain employees who elect to defer any selected portion of their salary. As these deferrals occur, Payee defers an amount equal to the aggregate employee deferrals from its income stream received from Payor, which is retained by Payor and deposited into the trust account and held tax free as indemnification against Payee's obligations which arise upon the occurrence of a payable event under Part B of the Plan, which is the Payee's unfunded non-qualified deferred compensation plan. In this connection, the present invention provides a unique mechanism for the transmittal of amounts deferred from the Payor by the Payee to the indemnification trust accounts, as follows: 1) Payee, as agent for the Payor, periodically remits deferral amounts directly to the deferral accounts held by the Payor in trust, and 2) Payor makes reimbursement for such remittances by annually documented adjustments in the recorded amount of the Payee's compensation for services rendered to the Payor by the Payee. The system and method of the present invention provides closer control of amounts remitted to trust accounts than the controls provided by the prior art, thereby eliminating the expense and employee relations problems caused by continuous and recurring requests for reversals of transactions which would occur on a massive scale as employee/participants' requests for changes are expected to be a frequent occurrence. Amounts deferred are not taxed to the Payee or the Payee's employees and are owned by the Payor in trust and are held tax free until the occurrence of a payable event under part B, at which time the taxable benefits pass tax-deductibly through the Payee to the employee, who is taxed as the payments are received.

It may be seen from the preceding description that an improved employee deferred income system and method has been provided.

It is noted that the embodiment of the improved employee deferred income system and method described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1. A method for a deferred income plan for a taxable employer with an employee, said taxable employer being a payee of a non-taxable entity, said method comprising the steps of:
providing that said employee of said taxable employer elects to defer a portion of said employee's salary to form a deferred portion;
providing that said taxable employer has an obligation to pay said employee said deferred portion of said employee's salary at a future time;
providing that said taxable employer elects to defer a deferred amount equal to said deferred portion of said employee's salary from income payable to said taxable employer from said non-taxable entity;
providing that said non-taxable entity provides an amount equal to said deferred amount for a trust account to thereby indemnify said taxable employer against said obligation of said taxable employer to pay said employee said deferred portion; and
providing that a first payable event triggers a payment of at least a portion of said deferred amount from said indemnification trust account.

2. The method of claim 1, further comprising:
providing that said non-taxable entity administers said trust account.

3. The method of claim 1, further comprising:
providing that an agent of said non-taxable entity administers said trust account.

4. The method of claim 3, further comprising:
providing that said taxable employer acts as said agent of said non-taxable entity to administer said trust account.

5. The method of claim 4, further comprising:
said taxable employer remits said deferred amount into said trust account and said non-taxable entity reimburses said taxable employer for said deferred amount.

6. The method of claim 1, further comprising:
providing that said trust account is for the benefit of said taxable employer.

7. The method of claim 1, further comprising:
providing that said payment is made to said taxable employer who then forwards an amount equal to said payment to said employee.

8. The method of claim 1, further comprising:
providing that said payment is made directly to said employee.

9. The method of claim 1, further comprising:
providing said trust account is set up in the name of said employee.

10. The method of claim 1, further comprising:
providing that said deferred amount in said trust fund is subject to a risk of forfeiture until an occurrence of said first payable event.

11. The method of claim 10, wherein:
said risk of forfeiture continues throughout an accumulation period and a payout period.

12. The method of claim 1, further comprising:
providing that said first payable event is defined in an agreement between said taxable employer and said employee.

13. The method of claim 1, further comprising:
providing that said employee can elect any portion of said employee's salary.

14. A deferred income system for use in paying a deferred income to one or more employees of a taxable employer wherein a non-taxable entity has a first obligation to said taxable employer, said system comprising:
a second obligation by said taxable employer for future payment of said deferred income to said one or more employees;
an agreement between said taxable employer and said non-taxable entity for payment of a portion of said first obligation such that a deferred amount equal to said deferred income is utilized to fund one or more trust accounts; and
an agreement between said taxable employer and said one or more employees for a payable event related to each of said one or more employees which triggers a payment from a respective of said one or more trust accounts.

15. The system of claim 14, further comprising:
an election by each of said one or more employees for deferring said deferred income from a respective salary of said one or more employees.

16. The system of claim 15, wherein said election may be for any amount up to an amount equal to said respective salary of said one or more employees.

17. The system of claim 14, further comprising:
said non-taxable entity or an agent of said non-taxable entity administers said one or more trust accounts.

18. A method for setting up a deferred compensation plan, said method comprising:
providing that as between a taxable employer and an employee of said taxable employer that said employee elects to defer a deferred amount of said employee's income payable by said taxable employer to said employee;
providing that as between said taxable employer and a non-taxable entity that said non-taxable entity defers an amount from income to said taxable employer from said non-taxable entity equal to said deferred amount;
providing for a trust account to be funded by an amount equal to said deferred amount; and
providing for a payable event which triggers a payment from said trust account related to said deferred amount.

19. The method of claim 18, further comprising:
providing that said deferred amount is subject to a risk of forfeiture until said payable event.

20. The method of claim 18, further comprising:
providing that said taxable employer acts an agent of said non-taxable entity for administering said trust account.
